(19) United States
(12) Patent Application Publication
(10) Pub. No.: US 2016/0318718 A1
(43) Pub. Date: Nov. 3, 2016

(54) APPARATUS FOR AUTOMATICALLY TRANSPORTING 3D PRINTED PARTS BETWEEN MANUFACTURING AND PROCESSING STATIONS

(71) Applicant: Board of Regents, The University of Texas System, Austin, TX (US)

(72) Inventors: David Espalin, El Paso, TX (US); Eric MacDonald, El Paso, TX (US); Ryan Wicker, El Paso, TX (US)

(73) Assignee: Board of Regents, The University of Texas System

(21) Appl. No.: 15/138,655

(22) Filed: Apr. 26, 2016

Related U.S. Application Data
(60) Provisional application No. 62/154,360, filed on Apr. 29, 2015.

(51) Int. Cl. B65G 47/90; B25J 15/00

(52) U.S. Cl. CPC B65G 47/90; B25J 15/0014; B65G 2207/22

(57) ABSTRACT

Systems and methods for transporting parts between manufacturing and processing stations. A portable platform can be implemented in association with a robot for transporting the portable platform to and from a group of manufacturing and processing stations. The robot includes a robot arm with an end effector that includes a gripping mechanism that is actuated to mate with a gripping block affixed on the portable platform, thereby reducing errors in registration and relieving an operator of a need to manually remove parts with respect to the manufacturing and processing stations. An advantage of this system/method is that the robot can be made available to a wide variety of other tasks such as post fabrication assembly.

### CROSS-REFERENCE TO PROVISIONAL APPLICATION

This application clams priority under 35 U.S.C. 119(e) to U.S. Provisional Patent Application Ser. No. 62/154,360 entitled, “Apparatus for Automatically Transporting 3D Printed Parts Between Manufacturing and Processing Stations,” which was filed on Apr. 29, 2015, the disclosure of which is incorporated herein by reference in its entirety.

### TECHNICAL FIELD

Embodiments are related to the field of additive manufacturing (AM) and, more particularly, to the of printing three-dimensional (3D) objects utilizing material extruders with translational and rotational degrees of freedom. Embodiments also relate to the field of fused deposition modeling.

### BACKGROUND

3D printing is an additive manufacturing process for making three-dimensional objects of arbitrary shapes from digital models. Other terms used synonymously to refer to 3D printing include additive manufacturing, layer manufacturing, rapid prototyping, layer-wise fabrication, solid freeform fabrication, and direct digital manufacturing. In 3D printing, successive layers of a material are laid down adjacently to form the objects. Typically, a round or ribbon like material is extruded through a movable nozzle.

Some 3D printing or Additive Manufacturing process and systems involve the use of a fused deposition process or a fused deposition modeling machine to dispense a thermoplastic model material to build parts one layer at a time. Fused deposition modeling is a process in which the material is dispensed in a flowable state into an environment which is at a temperature below the flowable temperature of the material, and which then hardens after being allowed to coot This process takes place within an envelope that is maintained at an elevated temperature specific to the thermoplastics being used. The thermoplastics are deposited on a disposable plastic build sheet that is held to a fixed build platform via vacuum.

Disadvantageously, this approach does not allow the accurate and convenient removal and replacement of partially-built parts, which allows for intermittent processing with complementary manufacturing. Such additional processes could include the machining of the exterior or interior of the part to achieve improved feature resolution or surface roughness, introducing electronic components and interconnections to create a circuit within the part, embedding wiring structures to reinforce the plastic part, or embedding metal foils to act as antennas or, for example, ground planes or electromagnetic shields within the plastic part.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved 3D printing or additive manufacturing system and method.

It is another aspect of the disclosed embodiments to provide for an apparatus, system, and method for automatically transporting 3D printing parts between manufacturing and processing stations.

The aforementioned aspects and other objectives and advantages can now be achieved as described herein. Systems and methods for transporting parts between manufacturing and processing stations are disclosed herein. A portable platform can be implemented in association with a robot (or another conveyance system/apparatus, such as, for example, a linear slide) for transporting the portable platform to and from a group of manufacturing and processing stations. The robot includes a robot arm with an end effector that includes a gripping mechanism that is actuated to mate with a gripping block affixed on the portable platform, thereby reducing errors in registration and relieving an operator of a need to manually remove parts with respect to the manufacturing and processing stations.

In some embodiments, the group of manufacturing and processing stations can include at least one 3D printing machine. In another embodiment, a leveling plate can be provided with respect to the manufacturing and processing stations, wherein the leveling plate includes a set of location pins fixed on the leveling plate and which mate respectively with a set of bushings located at the bottom of the portable platform. The leveling plate is located within a manufacturing and/or processing station. In some embodiments, the leveling plate can include a calibration mechanism that allows for planarization between the portable platform and an XY plane of one or more of the manufacturing and processing stations. The calibration mechanism can also be configured to remove the rotation and/or offset in a coordinate axis between two or more of the manufacturing and processing stations.

In another example embodiment, a travel envelope can be configured, which maintains a part being built by one or more of the manufacturing and processing stations at an elevated temperature to ensure dimensional stability during transport on the portable platform actuated by the robot arm. In some embodiments, the travel envelope can be equipped with a heater and a blower to produce heated and forced convection.

In still another example embodiment, one or more thermocouples and controllers can be included with the travel envelope to create a closed-loop arrangement that maintains a desired temperature or a temperature profile of choice with respect to the manufacturing and processing stations. The travel envelope can be configured to enable the control of various environmental factors including, but not limited to, temperature, humidity, ultraviolet light, pressure, and gas, etc. In yet another embodiment, the travel envelope can be further equipped with a retractable door.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a system of manufacturing stations that surround a robot arm capable of transporting one or more parts to all surrounding stations, in accordance with a preferred example embodiment;

FIG. 2 illustrates a robot end effector for gripping and removing/depositing a portable platform, in accordance with a preferred example embodiment;

FIG. 3 illustrates a portable platform with gripping block and vacuum lines for fixing a build sheet onto the platform, in accordance with an alternative example embodiment;

FIG. 4 illustrates a leveling plate with locating pins and adjustment screws, in accordance with another example embodiment; and

FIG. 5 illustrates travel envelopes that can maintain parts at a prescribed temperature during transport, in accordance with an example alternative embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can he embodied in many different forms and should not be construed as limited to the embodiments set forth herein; rather, these embodiments are provided so that this disclosure will be thorough and complete, and will fully convey the scope of the invention to those skilled in the art. Like numbers refer to identical, like, or similar elements throughout, although such numbers may be referenced in the context of different embodiments. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed embodiments can be implemented in the context of additive manufacturing technologies commonly used for modeling, prototyping, and production applications for use with, for example, 3D printing. Such an approach functions based on an “additive” principle by laying down material in layers. A plastic filament or metal wire can be unwound from a coil and supplies material to produce a part.

The disclosed system and methods of use of such a system is based on the discovery that manually performing additional actions (i.e., removing the part from the manufacturing machine, placing the part on another processing station, placing the part in the manufacturing machine) introduces errors in registration and often limits the number of interruptions a designer will incorporate because it requires an operator to execute the motion manually, which can be cumbersome and time consuming. Another discovery is that removing the thermoplastic part from the envelope's elevated temperature and placing it into room temperature or a substantially lower temperature can cause warping of the part because of thermal shock. This warping was also discovered to cause dimensionally accuracy errors, which lead to faulty parts or difficulty in performing the additional processes because the dimensions of the part may not match what was considered during tool path planning. Maintaining parts during fabrication at elevated temperatures also fosters better interlayer adhesion, which can improve Z strength—a known weakness of material extrusion additive manufacturing technologies.

The registration error problem is solved in one aspect by using a portable platform in combination with accurate motion control and locating features. In this manner, the portable platform can be used with multiple manufacturing and processing stations that contain a common configuration of locating pins and ensure the platform is always registered the same. The robot arm contributes to the solution by automating the process and relieving the operator of manually moving the part. The thermal shock problem is solved by using a travel envelope that maintains the part at elevated temperatures during the transport of the part being bunt. The inclusion of both a portable platform and travel envelope allows the use of multiple manufacturing and processing technologies to contribute towards manufacturing one single part with improved registration, build time, and dimensional accuracy.

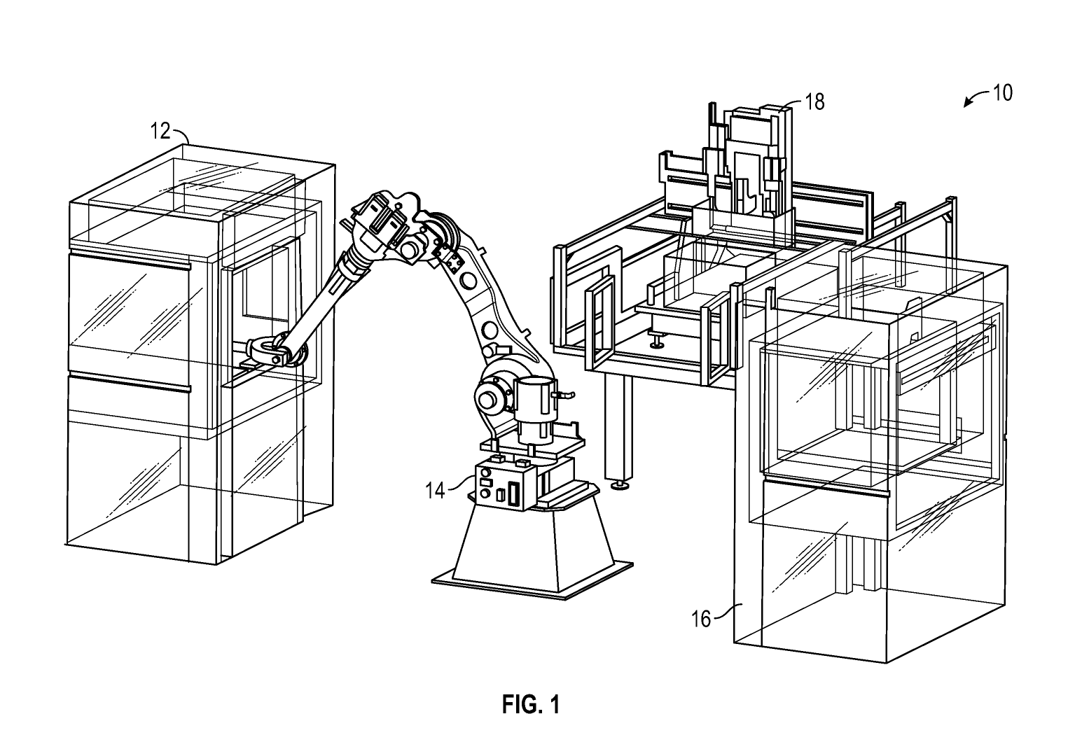

FIG. 1 illustrates a system 10 of manufacturing machines 12, 16 that surround a robot arm 14 capable of transporting one or more parts to all surrounding stations, in accordance with a preferred embodiment. Note that in the example shown in FIG. 1, robot arm 14 can be implemented as a six-axis robot arm. Note that as utilized herein, the term robot refers to any mechanical or virtual artificial agent such as an electro-mechanical machine that is guided by a computer program and/or electronic circuitry, and which may be autonomous or semi-autonomous.

System 10 can also incorporate a CNC router configured with capabilities of machining, direct-write, and wire embedding component 18. Such a CNC (Computer Numerical Control) router is a computer controlled cutting machine for cutting various hard materials, such as, for example, wood, composites, aluminum, steel, plastics, and foams. The CNC router is thus controlled by a computer and coordinates can be uploaded into the machine controller from a separate CAD (Computer Aided Design) program. The CNC router may include two software applications—one program to make designs (e.g., CAD) and another to translate such designs into a “G-Code” program of instructions for the machine (CAM or Computer Aided Machining). In some example embodiments, the CNC router may be controlled directly by manual programming, and CAD/CAM can be employed for contouring and speeding up the programming process.

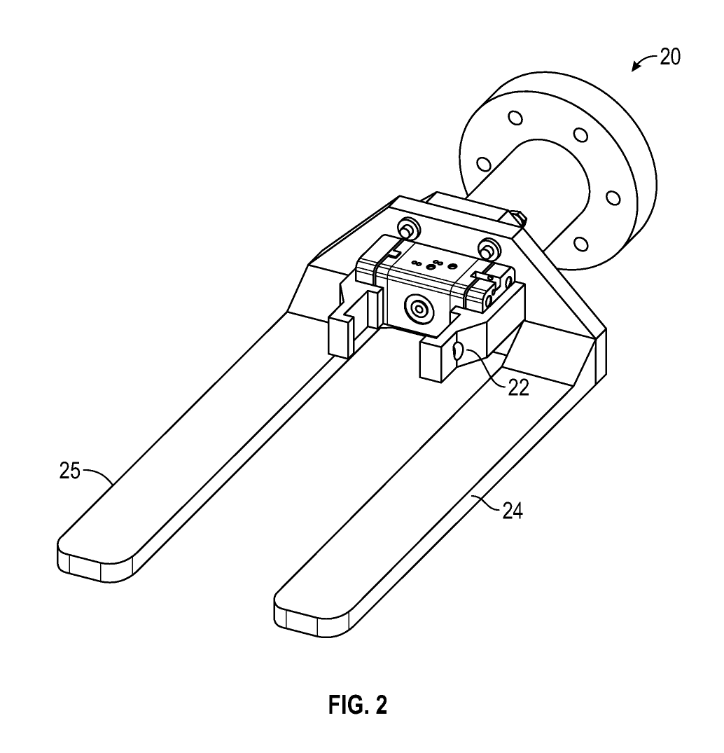

FIG. 2 illustrates a robot end effector 20 for gripping and removing/depositing a portable platform, in accordance with a preferred embodiment. The effector 20, which functions with the system 10 includes one or more grippers 22 and support beams 24, 25 for the portable platform as shown in FIG. 2. In some embodiment, the effector 20 also includes a vacuum port for supplying vacuum to the portable platform to fix the build sheet on, the platform.

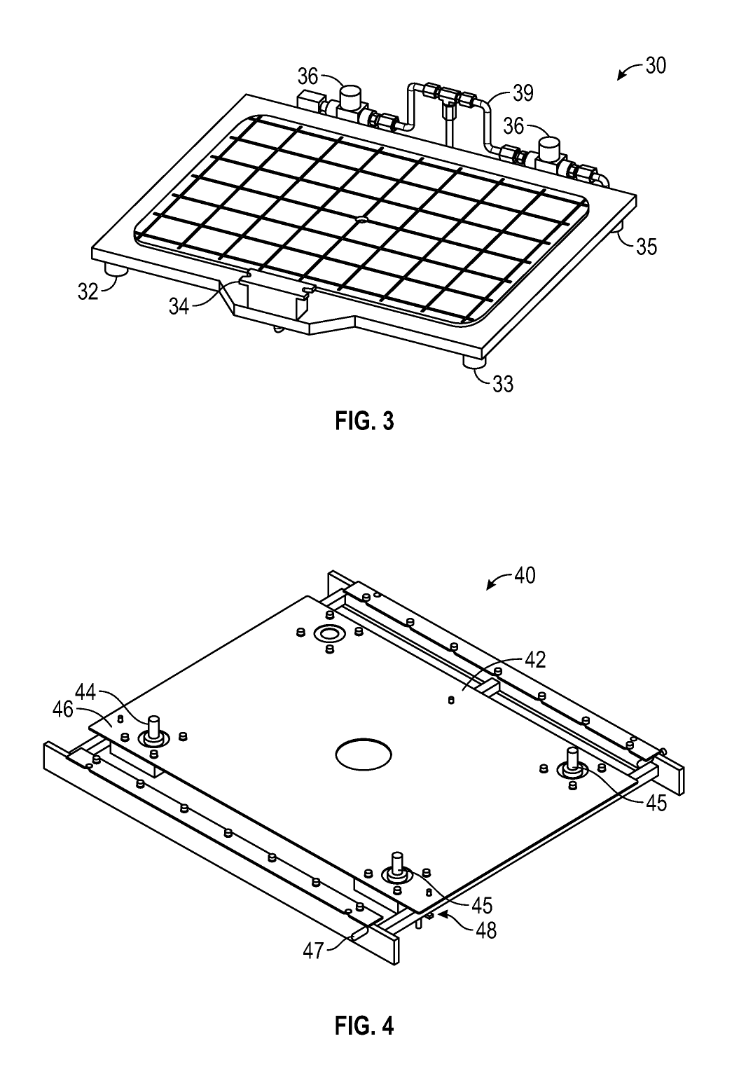

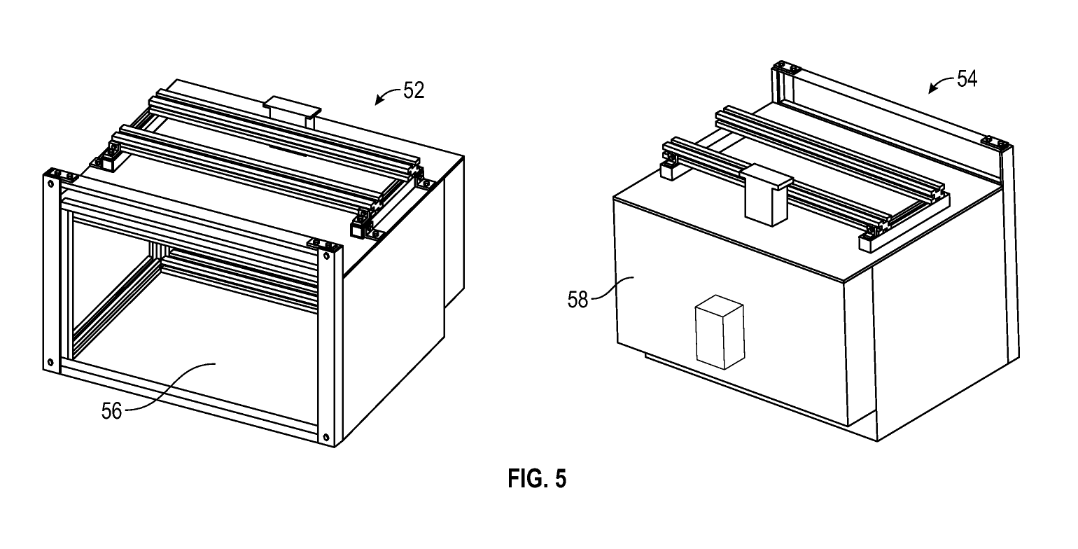

FIG. 3 illustrates a leveling plate 30 with locating pins and adjustment screws, in accordance with an alternative embodiment. In the embodiment of FIG. 3, the leveling plate 30 is shown as including one or more brushings 32, 33, 35 (and additional brushings as needed) for respective locating pins (e.g., see FIG. 4, location pins 44, 45, etc.), along with a gripping block 34. A vacuum component 39 is also included with the leveling plate 30 along with two or more check valves 36. Note that the system 10 can pull the vacuum component 39 (i.e., vacuum) from two locations, i.e., the robot in transit and at the station(s) during processing.

FIG. 4 illustrates a leveling plate component 42 with locating pins 44, 45, etc., and adjustment screws 42, 46, 47, 48, etc., in accordance with another embodiment. The leveling plate component 42 can be utilized with the embodiment shown in. FIG. 3 or with another embodiment depending upon design considerations. Adjustment screws 42, 48, and 46 shown in FIG. 4 constitute planarization adjustment screws. The adjustment screw 47, on the other hand, is a rotation adjustment screw. FIG. 5 illustrates travel envelopes 52, 54 that can maintain parts at a prescribed temperature during transport, in accordance with an alternative embodiment. The configurations shown in FIGS. 4-5 can be implemented with system 10 or variations to system 10.

The system 10 and variations thereof described herein can automatically remove a part from a 3D printing machine and place that part in a separate processing station to perform some intermittent complementary manufacturing process after which the part is placed back into the 3D printing machine to resume the building process. While these operations can be performed manually, the problem in doing so is that errors are introduced in registration and dimensional accuracy of the produced parts due to the thermal cycling. Additionally, manual intervention often limits the number of interruptions a designer will incorporate because it requires an operator to execute the motion manually, which can be cumbersome and time consuming. To facilitate the repetitive motion of transporting a part between stations, a robot (or another conveyance system/apparatus) can be employed to transport a portable platform to and from the various manufacturing and processing stations as shown in FIG. 1. Note that a conveyance system/apparatus such as, for example, a linear slide can be utilized in association with the robot or in lieu of the robot.

The robot's end effector 20 depicted in FIG. 2 thus includes a gripping mechanism 22 that is actuated to mate with a gripping block that is fixed on the portable platform. When the portable platform is deposited into a 3D printing machine or alternative processing station, the bushings (e.g., brushing 32 shown in FIG. 3) located at the bottom of the portable platform mate with a set of locating pins (e.g., locating pins 44, 45 shown in FIG. 4) that are fixed on the leveling plate (see FIGS. 3-4) located within the manufacturing or processing station.

The locating pins 44, 45 ensure that the portable platform is located within the station to a specified tolerance, which mitigates registration errors. The same configuration of locating pins 44, 45 can be included in other manufacturing and processing stations of the system to ensure proper registration.

Another feature of the leveling plate configuration shown in FIGS. 3-4 involves a calibration mechanism that allows for (1) ensuring planarization between the XY plane of the 3D printing machine and the portable platform, and (2) removing any rotation or offset in coordinate axis between various manufacturing machines.

The thermal shock problem can be solved by utilizing a travel envelope such as the example travel envelopes 52, 54 as shown in FIG. 5, which can maintain the part being built at an elevated temperature to ensure dimensional stability during transport. The travel envelope can be equipped with heaters and blowers to produce heated, forced convection. For example, a fin strip heater and blower component 58 is shown in FIG. 5 with respect to the travel envelope configuration 54. Additionally, thermocouples and a controller is included to create a closed-loop control system that accurately maintains a desired temperature or a temperature profile of choice. Beyond the control of temperature, the travel envelope enables the control of other environmental factors including humidity, ultraviolet light, pressure, and gases. Since the fabricated part can create an obstruction when removing the travel envelope, a retractable door 56 as shown in FIG. 5 is preferably included so that the part is avoided during motion of the travel envelope. One advantage of disclosed system/method is that the robot can be made available to a wide variety of other tasks such as post fabrication assembly.

The disclosed embodiments thus provide for a system/apparatus that allows for automatically removing a part from a 3D printing machine and placing that part in a separate processing station to perform some intermittent process after which the part is placed back into the 3D printing machine to resume the building process. While these operations can be performed manually, the problem in doing so is that errors are introduced in registration and dimensional accuracy of the produced parts. Additionally, manual intervention often limits the number of interruptions a designer will incorporate because it requires an operator to execute the motion manually, which can be cumbersome and time consuming.

To facilitate the repetitive motion of transporting a part between stations, a robot is used to transport a portable platform to and from the various manufacturing and processing stations (e.g., see FIG. 1). The robot's end effector (e.g., see FIG. 2) can be configured as a gripping mechanism that is actuated to mate with a gripping block that is fixed on the portable platform (e.g., see FIG. 3). When depositing the portable platform into a 3D printing machine or alternative processing station, the bushings located at the bottom of the portable platform mate with a set of locating pins that are fixed on a leveling plate (e.g., see FIG. 4) located within the manufacturing or processing station.

The locating pins ensure that the portable platform is located within the station to a specified tolerance, which mitigates registration errors. The same configuration of locating pins are included in the other manufacturing and processing stations of the system to ensure proper registration.

Another feature of the leveling plate is the calibration mechanism which allows for (1) ensuring planarization between the XY plane of the 3D Printing machine and the portable platform, and (2) removing any rotation or offset in coordinate axis between various manufacturing machines. The thermal shock problem is solved by using a travel envelope (FIG. 5) that maintains the part being built at an elevated temperature to ensure dimensional stability during transport. The travel envelope can be equipped with heaters and blowers to produce heated, forced convection.

Additionally, thermocouples and a controller is included to create a closed-loop control system that accurately maintains a desired temperature or a temperature profile of choice. Beyond the control of temperature, the travel envelope enables the control of other environmental factors including humidity, ultraviolet light, pressure, and gases. Since the fabricated part can create an obstruction when removing the travel envelope, a retractable door is included so that the part is avoided during motion of the travel envelope.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may he subsequently made by those skilled in the art, which are also intended to be encompassed by the following claims.

What claimed is:

1. A system for transporting parts between manufacturing and processing stations, said system comprising:
a portable platform; and
a robot for transporting said portable platform to and from a plurality of manufacturing and processing stations, said robot having a robot arm with an end effector that includes a gripping mechanism that is actuated to mate with a gripping block affixed on said portable platform, thereby reducing errors in registration and relieving an operator of a need to manually remove parts with respect to said plurality of manufacturing and processing stations.

2. The system of claim 1 wherein said plurality of manufacturing and processing stations includes at least one 3D printing machine.

3. The system of claim 1 further comprising a leveling plate with respect to at least one of said plurality of manufacturing and processing stations, wherein said leveling plate includes a set of location pins fixed on said leveling plate and which mate respectively with a set of bushings located at a bottom of said portable platform.

4. The system of claim 3 wherein said leveling plate comprises a calibration mechanism that allows for planarization between said portable platform and an XY plane of at least one of said plurality of manufacturing and processing stations.

5. The system of claim 3 wherein said leveling plate comprises a calibration mechanism that removes a rotation and/or an offset in a coordinate axis between at least two of said plurality of manufacturing, and processing stations.

6. The system of claim 1 further comprising a travel envelope that maintains a part being configured by at least one of said plurality of manufacturing and processing stations at an elevated temperature to ensure dimensional stability during transport on said portable platform actuated by said robot arm.

7. The system of claim 6 wherein said travel envelope comprises a heater and a blower to produce heated and forced convection.

8. The system of claim 6 wherein said travel envelope further comprises at least one thermocouple and a controller to create a closed-loop arrangement that maintains a desired temperature or a temperature profile of choice with respect to said elevated temperature by at least one of said plurality of manufacturing and processing stations.

9. The system of claim 6 wherein said travel envelope further enables a control of a plurality of environment factors including humidity, ultraviolet light, pressure, and gas.

10. The system of claim 6 wherein said travel envelope further includes a retractable door so that said part is avoided during a motion of said travel envelope.

11. The system of claim 1 wherein said robot arm comprises a six-axis robot arm.

12. The system of claim 1 further comprising a conveyance apparatus for moving said portable platform.

13. The system of claim 12 wherein said conveyance apparatus comprises a linear slide.

14. A system for transporting parts between manufacturing and processing stations, said system comprising:
a portable platform; and
a conveyance apparatus for transporting said portable platform to and from a plurality of manufacturing and processing stations, said conveyance apparatus having an arm with an end effector that includes a gripping mechanism that is actuated to mate with a gripping block affixed on said portable platform, thereby reducing errors in registration and relieving an operator of a need to manually remove parts with respect to said plurality of manufacturing and processing stations.

15. The system of claim 4 wherein said plurality of manufacturing and processing stations includes at least one 3D printing machine.

16. The system of claim 14 wherein said conveyance apparatus comprises a linear slide.

17. A method for transporting parts between manufacturing and processing stations, said method comprising:
providing a portable platform;
automatically transporting said portable platform to and from a plurality of manufacturing and processing stations utilizing a robot, said robot having a robot arm with an end effector that includes a gripping mechanism; and
actuating said gripping mechanism to mate with a gripping block affixed on said portable platform and thereby reducing errors in registration and relieving an operator of a need to manually remove parts with respect to said plurality of manufacturing and processing stations.

18. The method of claim 17 further comprising providing a leveling plate with respect to at least one of said plurality of manufacturing and processing stations, wherein said leveling plate includes a set of location pins fixed on said leveling plate and which mate respectively with a set of bushings located at a bottom of said portable platform.

19. The method of claim 18 further comprising calibrating said leveling plate by allowing for planarization between said portable platform and an XY plane of at least one of said plurality of manufacturing and processing stations.

20. The method of claim 18 further comprising calibrating said leveling plate by removing a rotation and/or an offset in a coordinate axis between at least two of said plurality of manufacturing and processing stations.
